(19) United States
(12) Patent Application Publication
(10) Pub. No.: US 2008/0280164 A1
(43) Pub. Date: Nov. 13, 2008

(54) MICROPOROUS CARBON CATALYST SUPPORT MATERIAL

(75) Inventors: Radoslav Atanasoski, Edina, MN (US); Moses M. David, Woodbury, MN (US); Alison K. Schmoeckel, Stillwater, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/747,606

(22) Filed: May 11, 2007

(51) Int. Cl. H01M 2/14; B01J 21/18; C23C 4/04

(52) U.S. Cl. 429/12; 427/450; 502/180

(57) ABSTRACT

A microporous carbon catalyst support material includes a microporous carbon skeleton layer having an average pore size from 0.1 to 10 nanometers and being substantially free of pores greater than 1 micrometer and a plurality of catalyst particles on or within the microporous carbon skeleton layer.

### STATEMENT REGARDING FEDERALLY SPONSORED RESEARCH OR DEVELOPMENT

This invention was made with United States Government Support under Cooperative Agreement DE-FC36-03GO13106 awarded by the Department of Energy. The United States Government has certain rights in this invention.

### FIELD

The present disclosure is directed to a microporous carbon catalyst support material, fuel cell diffusion layers including the same, and fuel cells including the same.

### BACKGROUND

Fuel cells are electrochemical devices that produce usable electricity by the catalyzed combination of a fuel such as hydrogen and an oxidant such as oxygen. In contrast to conventional power plants, fuel cells do not utilize combustion. As such, fuel cells produce little hazardous effluent. Fuel cells convert hydrogen fuel and oxygen directly into electricity, and can be operated at higher efficiencies compared to internal combustion generators.

A fuel cell such as a proton exchange membrane fuel cell often contains a membrane electrode assembly (MEA), formed by an electrolyte membrane disposed between a pair of catalyst layers, which are correspondingly disposed between a pair of gas diffusion layers. The respective sides of the electrolyte membrane are referred to as an anode portion and a cathode portion. In a typical proton exchange membrane fuel cell, hydrogen fuel is introduced into the anode portion, where the hydrogen reacts and separates into protons and electrons. The electrolyte membrane transports the protons to the cathode portion, while allowing a current of electrons to flow through an external circuit to the cathode portion to provide power. Oxygen is introduced into the cathode portion and reacts with the protons and electrons to form water and heat.

### BRIEF SUMMARY

The present disclosure is directed to a microporous carbon catalyst support material, fuel cell diffusion layers including the same, and fuel cells including the same.

In a first embodiment, a microporous carbon catalyst support material includes a microporous carbon skeleton having an average pore size from 0.1 to 10 nanometers and being substantially free of pores greater than 1 micrometer, and a plurality of catalyst particles on or within the microporous carbon skeleton.

In another embodiment, a fuel cell gas diffusion layer includes a carbon fiber substrate layer, a microporous carbon skeleton layer adjacent the carbon fiber substrate layer, and a plurality of catalyst particles are on or within the microporous carbon skeleton layer. The microporous carbon skeleton layer has an average pore size from 0.1 to 10 nanometers and is substantially free of pores greater than 100 nanometers.

In a further embodiment, a fuel cell includes an electrolyte membrane having a first surface, and a fuel cell gas diffusion layer disposed on the first surface. The fuel cell gas diffusion layer includes a carbon fiber substrate layer, a microporous carbon skeleton layer adjacent the carbon fiber substrate layer, and a plurality of catalyst particles are on or within the microporous carbon skeleton layer. The microporous carbon skeleton layer has an average pore size from 0.1 to 10 nanometers and is substantially free of pores greater than 100 nanometers. At least selected catalyst particles are in contact with the first surface.

In another embodiment, a method of forming a fuel cell gas diffusion layer includes forming a hydrocarbon plasma from a hydrocarbon gas, depositing the hydrocarbon plasma adjacent the carbon fiber substrate layer to form a hydrocarbon layer, and heating the hydrocarbon layer and removing at least a portion of the hydrogen to form a microporous carbon skeleton layer having an average pore size from 1 to 10 nanometers and being substantially free of pores greater than 100 nanometers. A plurality of catalyst particles are on or within the microporous carbon skeleton layer.

### BRIEF DESCRIPTION OF THE DRAWINGS

The invention may be more completely understood in consideration of the following detailed description of various embodiments of the invention in connection with the accompanying drawings, in which:

FIG. 1 is a schematic cross-sectional view of an illustrative fuel cell;

FIG. 2 is a schematic cross-sectional view of an illustrative microporous carbon catalyst support material;

FIG. 3 is a schematic cross-sectional view of an illustrative fuel cell gas diffusion layer;

FIG. 4 is a graph of fuel cell results according to the Examples;

FIG. 5 is a graph of fuel cell results according to the Examples; and

FIG. 6 is a graph of AC impedance results according to the Examples.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

In the following description, reference is made to the accompanying drawings that form a part hereof, and in which are shown by way of illustration several specific embodiments. It is to be understood that other embodiments are contemplated and may be made without departing from the scope or spirit of the present invention. The following detailed description, therefore, is not to be taken in a limiting sense.

All scientific and technical terms used herein have meanings commonly used in the art unless otherwise specified. The definitions provided herein are to facilitate understanding of certain terms used frequently herein and are not meant to limit the scope of the present disclosure.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

The term “porous” when used with respect to a material means that the material contains a connected network of pores (which may, for example, be openings, interstitial spaces or other channels) throughout its volume.

The term “size” when used with respect to a pore means the pore diameter for a pore having a circular cross section, or the length of the longest cross-sectional chord that may be constructed across a pore having a non-circular cross-section.

The term “microporous” when used with respect to a material means that the material is porous with an average pore size of about 0.1 to 100 nanometers.

The term “amorphous” means a substantially randomly ordered non-crystalline material having no x-ray diffraction peaks or modest x-ray diffraction peaks.

The term “plasma” means a partially ionized gaseous or fluid state of matter containing reactive species that include electrons, ions, neutral molecules, free radicals, and other excited state atoms and molecules. Visible light and other radiation are typically emitted from the plasma as the species included in the plasma relax from various excited states to lower or ground states.

The term “hydrocarbon” refers to an organic consisting of the elements carbon and hydrogen.

The term “catalyst” refers to any substance that affects the rate of chemical reaction without itself being consumed or undergoing a chemical change.

The term “substantially free of pores greater than X” refers to less than 0.1% by number or less than 0.05% by number, or less than 0.01% by number of pores have a pore size greater than X.

This disclosure is directed to a microporous carbon catalyst support material, fuel cell diffusion layers including the same, and fuel cells including the same. The microporous carbon catalyst support material has a controlled pore size. In particular, the present disclosure is directed to a microporous carbon catalyst support material having a microporous carbon skeleton layer with an average pore size from 0.1 to 10 nanometers and substantially free of pores greater than 1 micrometer or less than 100 nanometers, and gas diffusion layers and fuel cell articles formed of these materials. These carbon skeletons are prepared by plasma depositing a random covalent network hydrocarbon film from the plasma gas phase and then heating (i.e., annealing) the hydrocarbon thin film to drive out the hydrogen from the cross-linked network or a carbon skeleton. The density of the random covalent network can be adjusted precisely during deposition which allows the pore size and its distribution in the resulting carbon skeleton to be accurately controlled. Thus, the porosity and surface area available for catalytic reaction can be controlled and designed for optimal fuel cell operation. In addition the resulting carbon skeleton layer can be hydrophobic or hydrophilic, as desired. While the present invention is not so limited, an appreciation of various aspects of the invention will be gained through a discussion of the examples provided below.

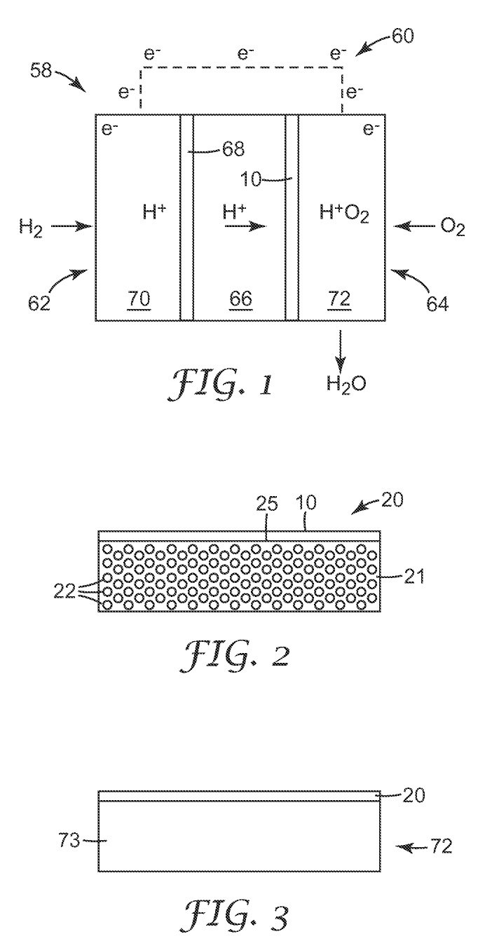

FIG. 1 is a schematic cross-sectional view of an illustrative fuel cell 58. The illustrated fuel cell or proton exchange membrane fuel cell includes a membrane electrode assembly (MEA) in use with external electrical circuit 60. Fuel cells are electrochemical cells which produce usable electricity by the catalyzed combination of a fuel such as hydrogen and an oxidant such as oxygen. Typical MEA's include a polymer electrolyte membrane 66 (also known as an ion conductive membrane (ICM)), which functions as a solid electrolyte. One face of the polymer electrolyte membrane 66 is in contact with an anode electrode layer 62 and the opposite face is in contact with a cathode electrode layer 64. Each electrode layer includes electrochemical catalysts 68, 10, often including a metal. Gas diffusion layers 72, 70 (GDL's) facilitate gas transport to and from the anode and cathode electrode materials and conduct electrical current.

In a typical fuel cell, protons are formed at the anode 62 via hydrogen oxidation and transported across the polymer electrolyte membrane 66 to the cathode 64 to react with oxygen, causing electrical current to flow in an external circuit 60 connecting the electrodes. The GDL may also be called a fluid transport layer (FTL) or a diffuser/current collector (DCC).

During operation of the MEA 58, hydrogen fuel H₂ is introduced into gas diffusion layer 70 at anode portion 62. The MEA 58 may alternatively use other fuel sources, such as methanol, ethanol, formic acid, and reformed gases. The fuel passes through gas diffusion layer 70 and over anode catalyst layer 68. At anode catalyst layer 68, the fuel is separated into hydrogen ions H⁺ and electrons e⁻. Electrolyte membrane 66 only permits the hydrogen ions to pass through to reach catalyst layer 10 and gas diffusion layer 72. The electrons generally cannot pass through electrolyte membrane 66. As such, the electrons flow through external electrical circuit 60 in the form of electric current. This current can power an electric load, such as an electric motor, or be directed to an energy storage device, such as a rechargeable battery.

Oxygen O₂ (oxygen gas or the oxygen in air) is introduced into gas diffusion layer 72 at cathode portion 64. The oxygen passes through gas diffusion layer 72 and over catalyst layer 10. At catalyst layer 10, oxygen, hydrogen ions, and electrons combine to produce water H₂O and heat. As discussed above, catalyst layer 10 exhibits good catalytic activity for reducing oxygen which increases the efficiency of the MEA 58.

At catalytic sites on each electrode, it is the GDL that provides both a path of electrical conduction and passage for reactant and product fluids such as hydrogen, oxygen and water. In many embodiments, hydrophobic GDL materials are preferred in order to improve transport of product water away from the catalytic sites of the electrode and prevent “flooding.”

Any suitable GDL material may be used. In many embodiments, the GDL includes a sheet or roll good material of carbon fibers. In these embodiments, the GDL is a carbon fiber construction selected from woven and non-woven carbon fiber constructions. Examplary commercially available carbon fiber constructions include: Toray™ Carbon Paper, SpectraCarb™ Carbon Paper, Zoltek™ Carbon Cloth, AvCarb™ P50 carbon fiber paper, and the like. In some embodiments, the GDL is coated or impregnated with a hydrophobizing treatment such as a dispersion of a fluoropolymer, such as polytetrafluoroethylene (PTFE). A microporous carbon skeleton layer, a thickness of 0.5 to 5 microns, can be provided (described below) on one or both major surfaces of the carbon fiber construction or sheet. In some embodiments, a layer of carbon nanotubes can be provided between the microporous carbon skeleton layer and the carbon fiber construction or sheet.

Electrolyte membrane 66 may be any suitable ion-conductive membrane. Examples of suitable materials for electrolyte membrane 66 include acid-functional fluoropolymers, such as copolymers of tetrafluoroethylene and one or more fluorinated, acid-functional comonomers. Examples of suitable commercially available materials include fluoropolymers under the trade designation “NAFION” from DuPont Chemicals, Wilmington, Del.

FIG. 2 is a schematic cross-sectional view of an illustrative microporous carbon catalyst support material 20. The microporous carbon catalyst support material 20 includes a microporous carbon skeleton layer 21 and a plurality of catalyst particles 10 on or within the microporous carbon skeleton layer 21. In many embodiments, the microporous carbon skeleton layer 21 consists essentially of carbon (e.g., is greater than 90 atomic % carbon or is greater than 95 atomic % carbon, or is greater than 99 atomic % carbon.)

The plurality of catalyst particles 10 can be any useful catalyst material. In many embodiments, the catalyst particles 10 are oxygen reducing and are useful as the cathode catalyst material in a fuel cell. In an embodiment, the catalyst 10 includes one or more catalyst material selected from platinum, ruthenium, osmium, platinum-ruthenium alloys, platinum-osmium alloys, platinum-palladium alloys, and platinum-M alloys (where M is at least one transition element selected from the group consisting of Ga, Ti, V, Cr, Mn, Fe, Co, Ni, Cu, Zn, and combinations thereof), and in another embodiment, from platinum, ruthenium, osmium, platinum-ruthenium alloys, platinum-osmium alloys, platinum-palladium alloys, platinum-cobalt alloys, and platinum-nickel alloys, in a further embodiment ternary alloys such as, for example, platinum-cobalt-manganese, or platinum-nickel-iron, are useful. Non-precious metal catalysts can also be utilized, as desired.

The plurality of catalyst particles 10 can form a catalyst layer on or adjacent to a surface 25 of the microporous carbon skeleton layer 21. In some embodiments, the plurality of catalyst particles 10 form a catalyst layer positioned between the surface 25 of the microporous carbon skeleton layer 21 and the electrolyte membrane 66. In some embodiments, the plurality of catalyst particles 10 are disposed on and within the microporous carbon skeleton layer 21. In some embodiments, at least selected catalyst particles 10 are disposed within the microporous carbon skeleton layer 21 during the formation of the microporous carbon skeleton layer 21 or hydrocarbon layer used to form the microporous carbon skeleton layer 21 (described below). In some embodiments, at least selected catalyst particles 10 are disposed on the microporous carbon skeleton layer 21 following the formation of the microporous carbon skeleton layer 21. In these embodiments, the catalyst particles 10 can be disposed on the microporous carbon skeleton layer 21 via known vapor deposition techniques, and the like.

The microporous carbon skeleton layer 21 defines a plurality of pores 22. The pores 22 have an average pore size from 0.1 to 10 nanometers and the microporous carbon skeleton layer 21 is substantially free of pores being greater than 1 micrometer. In many embodiments, the pores 22 have an average pore size from 0.1 to 10 nanometers and the microporous carbon skeleton layer 21 is substantially free of pores being greater than 100 nanometers.

The microporous carbon skeleton layer 21 has a porosity of 10% or greater, or 30% or greater, or 50% or greater, depending on how the microporous carbon skeleton layer 21 is formed (described below). In some embodiments, the microporous carbon skeleton layer 21 is optically transparent over the visible light spectrum or has an effective coefficient of extinction of less than 1, or less than 0.5, or less than 0.1 in the 400-800 nm region of the electromagnetic spectrum.

The microporous carbon skeleton layer 21 has a number of desirable characteristics. This material has a high porosity (e.g., greater than 10%, or greater than 30%, or greater than 50%), uniform small pore size (e.g., less than 100 nanometers, or less than 10 nanometers), high surface area (e.g., greater than 100 m²/g, or greater than 500 m²/g), inert (e.g., resistant to solvents, acids, bases, and no extractables), provides a precisely tailorable film thickness, provides high thermal stability, biocompatible, and is electrically conducting.

The microporous carbon catalyst support material 20 or microporous carbon skeleton layer 21 is formed from a hydrocarbon plasma. In many embodiments, the plasma is formed substantially only from a hydrocarbon material. The hydrocarbon plasma is formed from a hydrocarbon gas. In some embodiments, the hydrocarbon layer has greater than 50 atomic % carbon and less than 50 atomic % hydrogen. In further embodiments, the hydrocarbon layer has greater than 50 atomic % carbon and the remainder atomic % hydrogen. These atomic percents can be determined by combustion analysis.

The hydrocarbon gas can be any formed of any useful hydrocarbon. Examples of hydrocarbons include, but are not limited straight or branched chain alkanes, alkenes, alkynes, and cyclic hydrocarbons having up to ten carbon atoms. Suitable hydrocarbons include (C₁-C₁₀)alkane, (C₂-C₁₀)alkene, or (C₂-C₁₀)alkyne hydrocarbon gas. In some embodiments, the hydrocarbon gas is, for example, methane, ethane, propane, butane, benzene, cyclohexane, toluene, ethylene, propylene, acetylene, and butadiene. In certain embodiments, the hydrocarbon gas is butane or butadiene.

An amorphous hydrocarbon layer is formed by the hydrocarbon plasma. Then the amorphous hydrocarbon layer is annealed to remove hydrogen to form a microporous carbon skeleton layer. In many embodiments, substantially all of the hydrogen within the hydrocarbon layer is removed to form the microporous carbon skeleton layer.

The crystallinity and the nature of the bonding of a carbon deposit determines the physical and chemical properties of the deposit. Diamond is crystalline, whereas the amorphous hydrocarbon films described herein are a non-crystalline, amorphous material, as determined by x-ray diffraction. Diamond is essentially pure carbon, whereas these amorphous hydrocarbon films contain essentially carbon and hydrogen. Diamond has the highest packing density, or gram atom density (GAD), of any material at ambient pressure. Its GAD is 0.28 gram atoms/cc. These amorphous hydrocarbon films have a GAD ranging from about 0.20 to 0.28 gram atoms/cc. In contrast, graphite has a GAD of 0.18 gram atoms/cc. Diamond has an atom fraction of hydrogen of zero, while these amorphous hydrocarbon films have an atom fraction of hydrogen in a range from 0.2 to 0.8. Gram atom density is calculated from measurements of the weight and thickness of a material. “gram atom” refers to the atomic weight of a material expressed in grams.

Removal of hydrogen from the amorphous hydrocarbon layer creates pores or voids defined by a carbon skeleton. Since the GAD of these amorphous hydrocarbon layers can approach the GAD of diamond, the pore size can be designed to be very small and controllable (e.g., average 0.1 to 10 nanometers with substantially all pores less than 1 micrometer or less than 100 nanometers.

In many embodiments, a plasma deposition system includes electrodes, one or both of which are powered by RF and a grounded reaction chamber. A substrate is placed proximate the electrode and an ion sheath is formed around the powered electrode to establish a large electric field across the ion sheath. Plasma is generated and sustained by means of a power supply (an RF generator operating at a frequency in the range of about 0.001 Hz to about 100 MHz). To obtain efficient power coupling (i.e., wherein the reflected power is a small fraction of the incident power), the impedance of the plasma load can be matched to the power supply by means of a matching network that includes two variable capacitors and an inductor. In many embodiments, the substrate has a negative bias voltage or negative self-bias voltage and the voltage can be formed by direct current (DC).

Briefly, the grounded reaction chamber is partially evacuated, and radio frequency power is applied to one of two electrodes. A hydrocarbon source is introduced between the electrodes to form a hydrocarbon plasma that includes reactive species in proximity to the electrodes, and to also form an ion sheath proximate at least one electrode. The substrate is exposed to the reactive species within the ion sheath that is proximate an electrode to form a hydrocarbon layer on the substrate.

Deposition occurs at reduced pressures (relative to atmospheric pressure) and in a controlled environment. A hydrocarbon plasma is created in a reaction chamber by applying an electric field to a carbon-containing gas. Substrates on which a hydrocarbon film is to be deposited are usually held in a vessel or container in the reactor. Deposition of the hydrocarbon film can occur at rates ranging from about 1 nanometer per second (nm/second) to about 100 nm/second (about 10 Angstroms per second to about 1000 Angstroms per second), depending on conditions including pressure, power, concentration of gas, types of gases, relative size of electrodes, etc. In general, deposition rates increase with increasing power, pressure, and concentration of gas, but the rates will approach an upper limit.

Hydrocarbon species within the hydrocarbon plasma react on the substrate surface to form covalent bonds, resulting in an amorphous hydrocarbon film on the surface of the substrate. The substrate can be held in a vessel or container within an evacuable chamber that is capable of maintaining conditions that produce hydrocarbon film deposition. That is, the chamber provides an environment that allows for the control of, among other things, pressure, the flow of various inert and reactive hydrocarbon gases, voltage supplied to the powered electrode, strength of the electric field across the ion sheath, formation of a hydrocarbon plasma containing reactive hydrocarbon species, intensity of ion bombardment and rate of deposition of a hydrocarbon film from the hydrocarbon reactive species.

Prior to the deposition process, the chamber is evacuated to the extent necessary to remove air and any impurities. Inert gases (such as argon) may be admitted into the chamber to alter pressure. Once the substrate is placed in the chamber and it is evacuated, a hydrocarbon, and optionally a substance from which an additional component can be deposited, is admitted into the chamber and, upon application of an electric field, forms a hydrocarbon plasma from which the amorphous hydrocarbon film is deposited. At the pressures and temperatures of hydrocarbon film deposition (typically, about 0.13 Pascal (Pa) to about 133 Pa (0.001 to 1.0 Torr) (all pressures stated herein are gauge pressure) and less than 50 degrees centigrade), the hydrocarbon will be in the vapor form.

The electrodes may be the same size or different sizes. If the electrodes are different sizes, the smaller electrode will have a larger ion sheath (regardless of whether it is the grounded or powered electrode). This type of configuration is referred to as an “asymmetric” parallel plate reactor. An asymmetric configuration produces a higher voltage potential across the ion sheath surrounding the smaller electrode. Electrode surface area ratios can be from 2:1 to 4:1, or from 3:1 to 4:1. The ion sheath on the smaller electrode will increase as the ratio increases, but beyond a ratio of 4:1 little additional benefit is achieved. The reaction chamber itself can act as an electrode. One configuration includes a powered electrode within a grounded reaction chamber that has two to three times the surface area of the powered electrode.

In an RF-generated plasma, energy is coupled into the plasma through electrons. The plasma acts as the charge carrier between the electrodes. The plasma can fill the entire reaction chamber and is typically visible as a colored cloud. The ion sheath appears as a darker area around one or both electrodes. In a parallel plate reactor using RF energy, the applied frequency is preferably in the range of about 0.001 Megahertz (MHz) to about 100 MHz, preferably about 13.56 MHz or any whole number multiple thereof. This RF power creates a plasma from the hydrocarbon gas within the chamber. The RF power source can be an RF generator such as a 13.56 MHz oscillator connected to the powered electrode via a network that acts to match the impedance of the power supply with that of the transmission line and plasma load (which is usually about 50 ohms so as to effectively couple the RF power). Hence this is referred to as a matching network.

The ion sheath around the electrodes causes negative self-biasing of the electrodes relative to the plasma. In an asymmetric configuration, the negative self-bias voltage is negligible on the larger electrode and the negative bias on the smaller electrode is typically in the range of 100 to 2000 volts.

For planar substrates, deposition of dense diamond-like thin films can be achieved in a parallel plate reactor by placing the substrates in direct contact with a powered electrode, which is made smaller than the grounded electrode. This allows the substrate to act as an electrode due to capacitive coupling between the powered electrode and the substrate.

Selection of the heating conditions of the plasma deposited amorphous hydrocarbon film allows for the tailoring of the resulting microporous carbon skeleton layer 21. For example, the resulting microporous carbon skeleton layer 21 can be either hydrophobic or hydrophilic or a combination of hydrophobic and hydrophilic regions, depending on the selected heating conditions. In some embodiments, a hydrophobic microporous carbon skeleton layer 21 can be formed by heating the plasma deposited amorphous hydrocarbon film in an inert (or reducing) atmosphere and/or at a pressure less than atmospheric. In other embodiments, a hydrophilic microporous carbon skeleton layer 21 can be formed by heating the plasma deposited amorphous hydrocarbon film in an oxidizing atmosphere such as air, oxygen or steam, and at an atmospheric or greater pressure. In some embodiments, the microporous carbon skeleton layer 21 can be formed by heating the plasma deposited amorphous hydrocarbon film in an ammonia atmosphere, as desired.

FIG. 3 is a schematic cross-sectional view of an illustrative fuel cell gas diffusion layer 72 or 70. The fuel cell gas diffusion layer 72 or 70 includes the microporous carbon catalyst support material 20, described above, disposed adjacent to a carbon fiber substrate layer 73. The microporous carbon catalyst support material 20 and microporous carbon skeleton layer 21 can have any useful thickness such as, for example 0.1 to 10 micrometers or from 1 to 5 micrometers.

As described in relation to FIG. 1, a fuel cell gas diffusion layer 72 is disposed on a first surface of the electrolyte membrane 66. The fuel cell gas diffusion layer 72 includes a carbon fiber substrate layer 73 and a microporous carbon skeleton layer 21 (see FIG. 2) adjacent the carbon fiber substrate layer 73 and a plurality of catalyst particles 10 on or within the microporous carbon skeleton layer 21. In many embodiments, at least selected catalyst particles 10 are in contact with the first surface.

Any suitable carbon fiber substrate construction may be used. Exemplary carbon fiber substrates are described above. In many embodiments, the carbon fiber substrate has an average thickness of between 30 and 400 micrometers, or between 100 and 250 micrometers, or between 150 and 200 micrometers.

In some embodiments, a layer of carbon nanotubes is disposed or formed on the carbon fiber substrate and then the microporous carbon catalyst support material is disposed or formed on the layer of carbon nanotubes. The layer of carbon nanotubes can be any useful thickness such as, for example, from 1 to 25 micrometers, or from 1 to 15 micrometers. The layer of microporous carbon catalyst support material can be any useful thickness such as, for example, from 0.1 to 10 micrometers, or from 0.1 to 5 micrometers.

### EXAMPLES

Plasma deposited layers described herein were deposited using the following system:

MARC1 Plasma system: This built system was pumped by a turbomolecular pump (Balzers, Model TPH2000) backed by dry pumping station (Edwards roots pump EH1200 and a iQDP80 dry mechanical pump). The flow rate of gases was controlled by MKS digital flow controllers. Rf power was delivered at a frequency of 13.56 Mhz from a 3 kW RFPP power supply (Advanced Energy Model RF30H) through a matching network. The base pressure in the chamber prior to deposition of the hydrocarbon layers was 0.0013 Pa (1×10⁻⁵ Torr). Substrate samples were taped to the electrode by using kapton tape.

Three fuel cells were constructed utilizing three different cathode gas diffusion layers (Examples 1-3). The basic fuel cell was constructed utilizing an electrolyte membrane commercially available under the trade designation “NAFION 112” from DuPont Chemical Co., Wilmington, Del. Two “NAFION 112” membranes were placed between a prepared (Example 1-3) cathode gas diffusion layer (each described below) and an anode catalyst layer. The anode catalyst layer included a platinum/carbon-dispersed ink coated on a carbon-paper gas diffusion layer. The anode carbon-paper gas diffusion layer was fabricated by coating a gas diffusion micro-layer on one side of a carbon fiber paper (commercially available under the trade designation “AVCARB P50 Carbon Fiber Paper” from Ballard Material Products, Lowell, Mass.). The anode catalyst platinum loading ranged from 0.3 milligrams Pt/centimeter² to 0.4 milligrams Pt/centimeter². The resulting fuel cell was assembled in a 50-centimeter² test cell fixture (available from Fuel Cell Technologies, Albuquerque, N. Mex.) having quad-serpentine flow fields, at about 25% to about 30% compression.

### Example 1 (Comparative)

Freudenburg carbon cloth FC-H2315 from Freudenberg Non-Wovens Technical Division, Lowell, Mass., was utilized as the cathode gas diffusion layer.

### Example 2 (Comparative)

Freudenburg carbon cloth with carbon nanotubes was utilized as the cathode gas diffusion layer.

Synthesis of Carbon Nanotube Layer: Carbon nanotubes were grown on the Freudenburg carbon cloth described in Example 1 in a MARC1 Plasma system. A NiCr catalyst thin film was sputtered onto the carbon cloth to a thickness of roughly 50 Angstroms. Acetylene and ammonia gases were introduced at flow rates of 125 sccm and 1000 sccm respectively. The carbon cloth was heated by passing AC current through it and the temperature was maintained at 750 degrees centigrade. A DC plasma glow was superimposed on the carbon cloth by biasing it at −530 Volts relative to the chamber. Electrical isolation of the DC voltage from the AC current source was achieved by an isolation transformer. Carbon nanotubes were grown over the carbon cloth to a thickness of around 10 micrometers.

### Example 3

Freudenburg carbon cloth with carbon nanotubes and microporous carbon catalyst support (microporous carbon skeleton layer) on carbon nanotubes (from Example 2) was utilized as the cathode gas diffusion layer.

Synthesis of Microporous Carbon Skeleton Layer from Butadiene Gas: The MARC1 plasma system was used to first deposit a random covalent network hydrocarbon thin film from butadiene precursor gas. Annealing of this film causes dehydrogenation, leading to a porous carbon skeleton layer. The construction of Example 2 was taped onto the powered electrode and the chamber was pumped down to its base pressure. The sample was initially primed in an argon plasma to enable good adhesion of the plasma-deposited hydrocarbon film to the substrate. The conditions of the argon plasma priming are as follows:

Argon flow rate: 400 sccm
Pressure: 0.7 Pa (5 mTorr)
Rf Power: 1000 watts

### DC Self-Bias Voltage: −1052 Volts

Duration of treatment: 45 seconds

Deposition of Random Covalent Network Hydrocarbon Film: After priming the construction of Example 2 in an argon plasma, the hydrocarbon film was plasma-deposited by feeding 1,3-butadiene gas into the vacuum chamber. The conditions of plasma deposition are as follows:

Flow rate of 1,3-butadiene: 160 sccm
Process pressure: 2.7 Pa (20 mTorr)
Rf power: 50 watts

### DC Self-Bias Voltage: −260 to −192 Volts

Deposition time: 32 minutes

After completion of the run, a plasma-deposited hydrocarbon film having a thickness of 1000 nm was obtained on the construction of Example 2.

Annealing of the Hydrocarbon Film: The plasma-deposited hydrocarbon film was annealed in a vacuum oven at 590 degrees centigrade for one hour in an ammonia ambient with an ammonia flow rate maintained at 1000 sccm. The pressure in the chamber during annealing was 850 Pa (6.4 Torr).

The microporous carbon skeleton was characterized for pore size distribution using nitrogen (N₂) adsorption on a Autosorb-1 (Quantachrome Instruments) from relative pressures P/P₀ from 7×10⁻⁷ to 1 at a bath temperature of 77.35° K to generate an isotherm. The ambient temperature for the experiment was 297.57° K and barometric pressure was 97.77 kPa (733.35 mmHg). The data set thus obtained was analyzed with the software provided by Quantachrome (Autosorb v 1.51) using the Saito-Foley (SF) method and Density Functional Theory (DFT) method with a Non-Local DFT hybrid kernel for N₂ on carbon cylindrical pores at equilibrium. The two methods produced pore size distributions that are in good agreement. The Dubinin-Astakhov (DA) and Dubinin-Raduskevich (DR) methods produced comparable results. From these results, it was noted that the surface area of the microporous carbon skeleton layer is extremely high (637 m²/g) with the most surface area contributions coming from pores with 5-10 Angstom sizes. Furthermore, all the contribution to surface area is from pores less than 100 Angstroms.

### Results

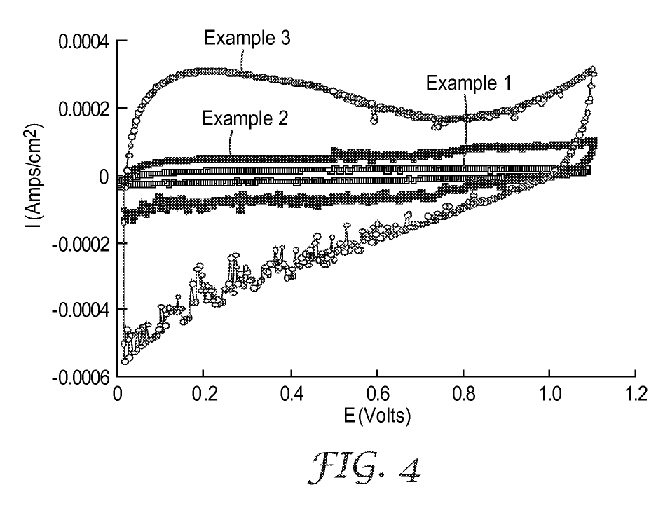

The characteristics of each example cathode gas diffusion layer were assessed in a 50 centimeter² fuel cell operating at 75 degrees Celsius. Hydrogen was introduced to the anode side of the cell at a flow rate of 500 standard cubic centimeters/minute (sccm). Nitrogen was introduced to the cathode side of the cell at a flow rate of 500 sccm. The humidification of both anode and cathode streams was approximately 132% relative humidity. The measurements were performed at ambient pressure. The surface area of each example cathode gas diffusion layer was assessed by measuring cyclic voltammograms at 50 millivolts per second with nitrogen flowing on the cathode side of the cell. FIG. 4 is a graph of fuel cell results according to the Examples. This graph is a comparison of cyclic voltammograms taken at 50 millivolts per second with nitrogen flowing to the cathode side of the cell for Examples 1-3. The relative surface area can be assessed by comparing the areas of the cyclic voltammograms taken under nitrogen. The surface area results are as follows: Example 1<Example 2<Example 3.

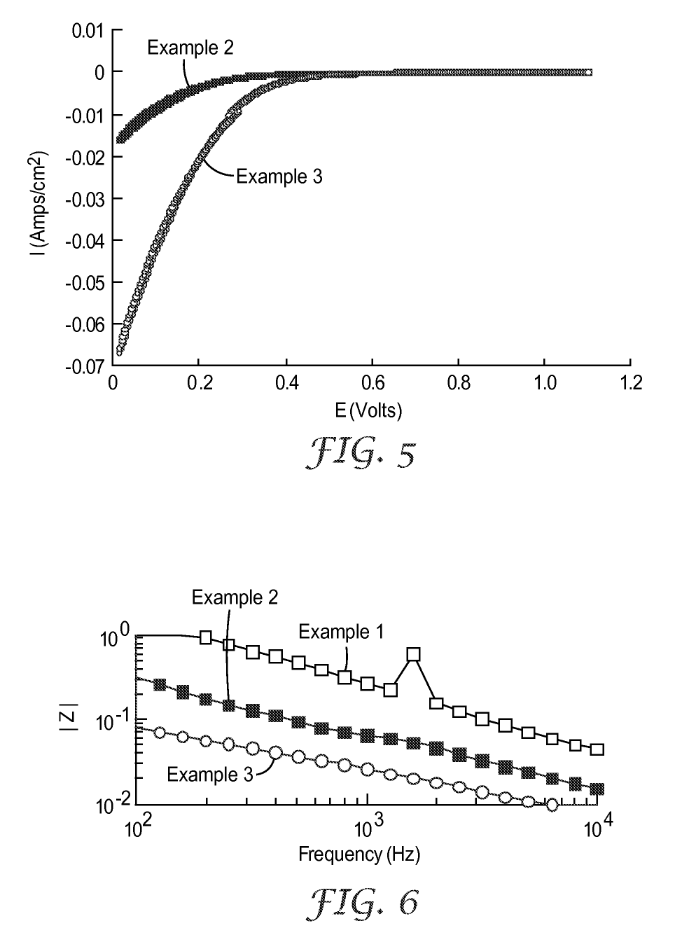

The inherent activity of each of the cathode gas diffusion layers were measured by cyclic voltammograms at 5 millivolts per second with oxygen flowing to the cathode side of the cell. For the activity measurements, the cell temperature was 80 degrees Celsius. Hydrogen was introduced to the anode side of the cell at a flow rate of 180 sccm and oxygen was introduced to the cathode at a flow rate of 335 sccm. Both gas streams were at approximately 100% relative humidity. The backpressure of the anode stream was approximately 207 kPa (30 pounds per square inch gauge) and the backpressure of the cathode stream was approximately 345 kPa (50 pounds per square inch gauge). The measurement involved recording voltage-current curves under oxygen (see FIG. 5) for the activity. FIG. 5 is a graph of fuel cell results according to the Examples. This graph is a comparison of oxygen response for Examples 2-3.

For surface area and activity methods a potentiostat (commercially available under the trade designation “SOLARTRON CELLTEST 1470” from Solartron Analytical, Oak Ridge, Tenn.) and a software package (commercially available under the trade designation “CORWARE” from Scribner Associates, Inc., Southern Pines, N.C.) were used.

Alternating current (AC) impedances were measured for each of Examples 1-3 pursuant to the following “AC impedance measurement” to determine resistance of the catalyst layer, as well as the interference resistance between the catalyst layer and the polymer electrolyte membrane. The AC impedance was measured using a potentiostat (commercially available under the trade designation “SOLARTRON CELLTEST 1470” from Solartron Analytical, Oak Ridge, Tenn.), with a frequency response analyzer (commercially available under the trade designation “SOLARTRON SI 1250” from Solartron Analytical), and a software package (commercially available under the trade designation “ZPLOT” from Scribner Associates, Inc., Southern Pines, N.C.). Measurements were taken at open circuit voltage under hydrogen in the frequency range of 1 hertz-10 kilohertz. The hydrogen streams introduced to the anode and cathode sides of the cell each had a flow rate of 500 standard cubic centimeters/minute (sccm). The measurements were taken at 75° C. with approximately 132% relative humidity at ambient pressure.

FIG. 6 is a graph of the AC impedances (total ohms measured for the 50-centimeter² active area) measured pursuant to the AC impedance measurement method for Examples 1-3. As shown, Example 2 exhibits lower impedances compared to Example 1. Similar to high surface area measured for the Example 3 support and the catalytic activity, this is believed to be due to the presence of these films on the original Freudenberg material. Both high and low frequency impedance for Example 3 is lower than Example 1 and Example 2.

The advantages of the carbon nanotube and microporous carbon skeleton modified support are illustrated by following the increase of the surface area of the modified support as the main prerequisite for a good catalyst support and, related to it, the increase in the inherent catalytic activity of the modified support for oxygen reduction as well as the decrease in the total impedance of the modified support for the electrochemical reaction taking place at its surface.

Thus, embodiments of the MICROPOROUS CARBON CATALYST SUPPORT MATERIAL are disclosed. One skilled in the art will appreciate that embodiments other than those disclosed are envisioned. The disclosed embodiments are presented for purposes of illustration and not limitation, and the present invention is limited only by the claims that follow.

What is claimed is:

1. A microporous carbon catalyst support material comprising:
a microporous carbon skeleton having an average pore size from 0.1 to 10 nanometers and being substantially free of pores greater than 1 micrometer; and
a plurality of catalyst particles on or within the microporous carbon skeleton.

2. A microporous carbon catalyst support material according to claim 1, wherein the microporous carbon skeleton has an average pore size from 1 to 10 nanometers and being substantially free of pores greater than 100 nanometers.

3. A microporous carbon catalyst support material according to claim 1, wherein the microporous carbon skeleton layer consists essentially of carbon.

4. A microporous carbon catalyst support material according to claim 1, wherein the microporous carbon skeleton layer has a porosity of 10% or greater.

5. A microporous carbon catalyst support material according to claim 1, wherein the microporous carbon skeleton layer is hydrophobic.

6. A microporous carbon catalyst support material according to claim 1, wherein the microporous carbon skeleton layer forms a layer having a thickness in a range from 0.1 to 10 micrometers and the catalyst is disposed on and within the microporous carbon skeleton layer, and the microporous carbon skeleton layer has an average pore size from 1 to 10 nanometers and is substantially free of pores greater than 100 nanometers.

7. A microporous carbon catalyst support material according to claim 1, wherein the catalyst particles are oxygen reducing.

8. A fuel cell gas diffusion layer, comprising:
a carbon fiber substrate layer;
a microporous carbon skeleton layer adjacent the carbon fiber substrate layer, the microporous carbon skeleton layer having an average pore size from 0.1 to 10 nanometers and being substantially free of pores greater than 100 nanometers; and
a plurality of catalyst particles on or within the microporous carbon skeleton layer.

9. A fuel cell gas diffusion layer according to claim 8, wherein the microporous carbon skeleton layer is hydrophobic.

10. A fuel cell gas diffusion layer according to claim 8, further comprising carbon nanotubes disposed on the carbon fiber substrate layer and the microporous carbon skeleton layer is disposed on the nanotubes.

11. A fuel cell gas diffusion layer according to claim 8, wherein the microporous carbon skeleton layer has a porosity of 30% or greater.

12. A fuel cell gas diffusion layer according to claim 8, wherein the catalyst particles are oxygen reducing.

13. A fuel cell, comprising:
an electrolyte membrane having a first surface; and
a fuel cell gas diffusion layer disposed on the first surface, the fuel cell gas diffusion layer comprising:
a carbon fiber substrate layer;
a microporous carbon skeleton layer adjacent the carbon fiber substrate layer, the microporous carbon skeleton layer having an average pore size from 0.1 to 10 nanometers and being substantially free of pores greater than 100 nanometers; and
a plurality of catalyst particles on or within the microporous carbon skeleton layer,
wherein at least selected catalyst particles are in contact with the first surface.

14. A fuel cell according to claim 13, wherein the microporous carbon skeleton layer is hydrophobic.

15. A fuel cell according to claim 13, further comprising carbon nanotubes disposed on the carbon fiber substrate layer and the microporous carbon skeleton layer is disposed on the nanotubes.

16. A fuel cell according to claim 13, wherein the catalyst particles are oxygen reducing.

17. A method of forming a fuel cell gas diffusion layer, comprising;
forming a hydrocarbon plasma from a hydrocarbon gas;
depositing the hydrocarbon plasma adjacent a carbon fiber substrate layer to form a hydrocarbon layer; and
heating the hydrocarbon layer and removing at least a portion of the hydrogen to form a microporous carbon skeleton layer having an average pore size from 1 to 10 nanometers and being substantially free of pores greater than 100 nanometers, wherein a plurality of catalyst particles are on or within the microporous carbon skeleton layer.

18. A method according to claim 17, wherein the forming step comprises forming a hydrocarbon plasma from a (C₁-C₁₀) alkane, (C₁-C₁₀) alkene, or (C₁-C₁₀) alkyne hydrocarbon gas.

19. A method according to claim 17, wherein the heating step comprises heating the hydrocarbon layer in an inert or reducing atmosphere and removing at least a portion of the hydrogen to form a hydrophobic microporous carbon skeleton layer.

20. A method according to claim 17, wherein the heating step comprises heating the hydrocarbon layer in an oxidizing atmosphere and removing at least a portion of the hydrogen to form a hydrophilic microporous carbon skeleton layer.
